(19) United States
(12) Patent Application Publication
(10) Pub. No.: US 2015/0349831 A1
(43) Pub. Date: Dec. 3, 2015

(54) PROTECTIVE CASE FOR AN ELECTRONIC DEVICE

(71) Applicant: Two Technologies, Inc., Horsham, PA (US)

(72) Inventors: David Henry Young, Ambler, PA (US); Roger Wayne Mick, Chalfont, PA (US); Michael Francis Walsh, Horsham, PA (US)

(21) Appl. No.: 14/293,808

(22) Filed: Jun. 2, 2014

(51) Int. Cl. H04B 1/3888; H04M 1/04; H04M 1/725

(52) U.S. Cl. CPC H04B 1/3888; H04M 1/7253; H04M 1/04; H04B 2001/3894

(57) ABSTRACT

In one embodiment, a protective case for use with an electronic device—such as a tablet computer or cell phone—is disclosed. The protective case configured to retain the electronic device, the protective case being designed from rigid, resilient materials, configured to provide impact resistance, temperature resistance, and water resistance to the electronic device. The protective case defines a battery compartment that is configured to permit the removable attachment of at least one hot-swappable battery. The at least one hot-swappable battery is configured to provide auxiliary power to the electronic device when it is disposed in the battery compartment. In another embodiment, the protective case is part of a kit, which includes the protective, a keyboard, a magnetic stripe reader, at least two hot-swappable batteries, at least one microprocessor, a stylus, a docking station, and a rain shield.

### TECHNICAL FIELD

The present disclosure relates to a protective case for an electronic device, such as a tablet computer or smart phone that has various features such as a keyboard, a magnetic stripe card reader, and/or a hot-swappable backup battery for providing auxiliary charge to the electronic device. The disclosure also relates to a computer-automated method of providing power to the electronic device using the hot-swappable backup battery.

### BACKGROUND

Protective cases are known in the art to protect electronic devices by absorbing shocks from falls and/or by blocking water or moisture from entering. However, typical protective cases do not enhance, provide, or add functionality to the device. In other words, protective cases typically do not enable the electronic device's user to perform additional functions with the electronic device that could not otherwise be performed without the protective case.

### SUMMARY

In one embodiment, a protective case for use with an electronic device—such as a tablet computer or cell phone—is disclosed. The protective case is configured to retain the electronic device, the protective case being designed from rigid, resilient materials, configured to provide impact resistance, temperature resistance, and water resistance to the electronic device. The protective case defines a case body, which further defines front and rear, left and right, and top and bottom surfaces. The rear surface defines a battery compartment. The protective case further includes at least two hot-swappable batteries wherein a first hot-swappable battery of the at least two hot-swappable batteries is removably attached to the battery compartment and replaceable by a second of the at least two hot-swappable batteries. The protective case further includes at least one microprocessor disposed within the protective case, the at least one microprocessor being electronically configured to establish data communication between the electronic device and any of the at least two hot-swappable batteries.

In some embodiments, a protective case is part of a kit that may include: a keyboard, a magnetic stripe reader, at least two hot-swappable batteries, at least one micro-processor, a stylus, a docking station, and a rain shield. The protective case, configured to retain an electronic, defines a case body, the case body further defining front and rear, and bottom and top surfaces. The rear surface contains a battery compartment. The keyboard is disposed on the front surface of the case body adjacent to the bottom surface, the keyboard comprising a plurality of keys, each of which correspond to at least one alpha-numeric character. The magnetic stripe reader is disposed on the rear surface of the case body adjacent to the bottom surface, and it is configured to read stored data from magnetic stripe cards. The at least one hot swappable battery is configured to be removably attachable to the protective case within the battery compartment. The at least one hot-swappable battery is configured to provide auxiliary power to the electronic device. The at least one microprocessor is disposed within the protective case, and it is electronically configured to establish data communication between the electronic device and any of the at least one hot-swappable battery, the keyboard, and the magnetic stripe reader. The stylus generally comprises a stylus body that is elongate along a central axis, the body extending from a pressure-sensitive stylus tip to a stylus head. The pressure-sensitive style tip is configured to engage with the screen of the electronic device. The stylus body further comprises a shift button configured to enable alternate functionality when the pressure-sensitive stylus tip engages with the screen of the electronic device. The docking station generally comprises a dock body, a docking portion, a battery charging portion, and a back dock portion. The docking portion is configured to electronically and physically engage with the electronic device when the electronic device is disposed within the protective case. The battery charging portion is configured to mate with the at least one of the at least two hot-swappable batteries so as to provide electrical power to that battery via an external power supply. The rain shield is a protective shield configured to cover an entirety of a screen of the electronic device. The rain shield defines a front rain shield surface and an opposed rear rain shield surface, where the rear rain shield surface is configured to abut the screen of the cell phone in the installed configuration. The rain shield is further configured to communicate with the screen of the cell phone when strong forces are applied to the front rain shield surface and to inhibit communication with the screen of the cell phone when weak forces are applied to the front rain shield surface.

In another embodiment, a rain shield is configured for use on a screen of an electronic device and comprises a film disposed on a top surface of the rain shield and an adhesive layer disposed on an opposed bottom surface of the rain shield. The adhesive layer is configured to abut the electronic device in the installed configuration so as to fixate the positioning of the rain shield with respect to the surface of the electronic device so as to limit translation of the rain shield. The rain shield bottom surface faces the screen of the electronic device so as to define a void therebetween. The rain shield retains a substantially rigid form when weak forces are imparted to the top surface such that the bottom surface does not penetrate the void, and the rain shield flexes toward the bottom surface when strong forces are imparted to the rain shield top surface, such that the rain shield bottom surface penetrates the void so as to make physical contact with the screen of the electronic device.

A further aspect of the present disclosure is a method for powering an electronic device. The method begins by instructing the electronic device to draw power from an internal rechargeable battery in the electronic device while the internal rechargeable battery has a certain power reserve of at least 50%. When the internal rechargeable battery has a power reserve of 50% or less, the electronic device is instructed to draw power from a first hot-swappable battery while the first hot-swappable battery has a power reserve of at least 50%. When the hot-swappable battery has a power reserve of 50% or less, the electronic device is instructed to display a first alert that signifies that the first hot-swappable battery should be replaced by a second hot-swappable battery. When the first hot-swappable battery is removed, the electronic device is instructed to draw power from the internal rechargeable battery until the second hot-swappable battery has replaced the first hot-swappable battery. A further aspect of the method is that the instruction steps are performed automatically by at least one microprocessor that is electronically connected to the electronic device, the internal rechargeable battery, and the hot-swappable battery.

### BRIEF DESCRIPTION OF THE DRAWINGS

The foregoing summary, as well as the following detailed description of an example embodiment of the application, will be better understood when read in conjunction with the appended drawings, in which there is shown in the drawings embodiments for the purposes of illustration. It should be understood, however, that the application is not limited to the precise arrangements and instrumentalities shown. In the drawings:

FIG. 1A is a front perspective view of a protective case housing an electronic device, such as a smart phone, the protective case disposed in a docking station;

FIG. 1B is a rear perspective view of the protective case illustrated in FIG. 1A;

FIG. 1C is a front plan view of the protective case illustrated in FIGS. 1A and 1B;

FIG. 1D is a rear plan view of the protective case illustrated in FIGS. 1A-1C;

FIG. 1E is side view of the protective case illustrated in FIGS. 1A-1D;

FIG. 1F is a top perspective view of the protective case illustrated in FIGS. 1A-1E;

FIG. 2A is a front perspective view of the protective case illustrated in FIGS. 1A-1F, without the electronic device;

FIG. 2B is a front plan view of the protective case illustrated in FIG. 2A;

FIG. 2C is a front plan view of a second embodiment of a protective case with a QWERTY-style keyboard;

FIG. 3A is a rear perspective view of the protective case illustrated in FIG. 2A with a portion of the case removed to show a hot-swappable battery;

FIG. 3B is a rear plan view of the protective case illustrated in FIGS. 2A and 3A.

FIG. 4A is a front perspective view of the docking station shown in FIG. 1A with a spare battery disposed therein;

FIG. 4B is a rear perspective view of the docking station illustrated in FIG. 4A;

FIG. 4C is a front plan view of the docking station illustrated in FIGS. 4A and 4B;

FIG. 5A is a top view of a rain shield for the electronic device;

FIG. 5B is a side view of the rain shield illustrated in FIG. 5A;

FIG. 5C is a bottom view of the rain shield illustrated in FIGS. 5A and 5B;

FIG. 5D is a top perspective view of the rain shield illustrated in FIGS. 5A-5C;

FIG. 5E is a side view of the rain shield illustrated in FIG. 5A-5D. that is fixated onto the electronic device in an installed configuration;

FIG. 6 is a stylus constructed in accordance with an embodiment; and

FIG. 7 is a flow diagram illustrating the operation of powering an electronic device using a hot-swappable battery.

FIG. 8A is top perspective view of a protective case housing an electronic device, such as a smart phone, with a printer disposed thereon

FIG. 8B is a bottom perspective view of the protective case illustrated in FIG. 8A.

FIG. 8C is a side view of the protective case illustrated in FIGS. 8A-8B.

### DETAILED DESCRIPTION OF THE DRAWINGS

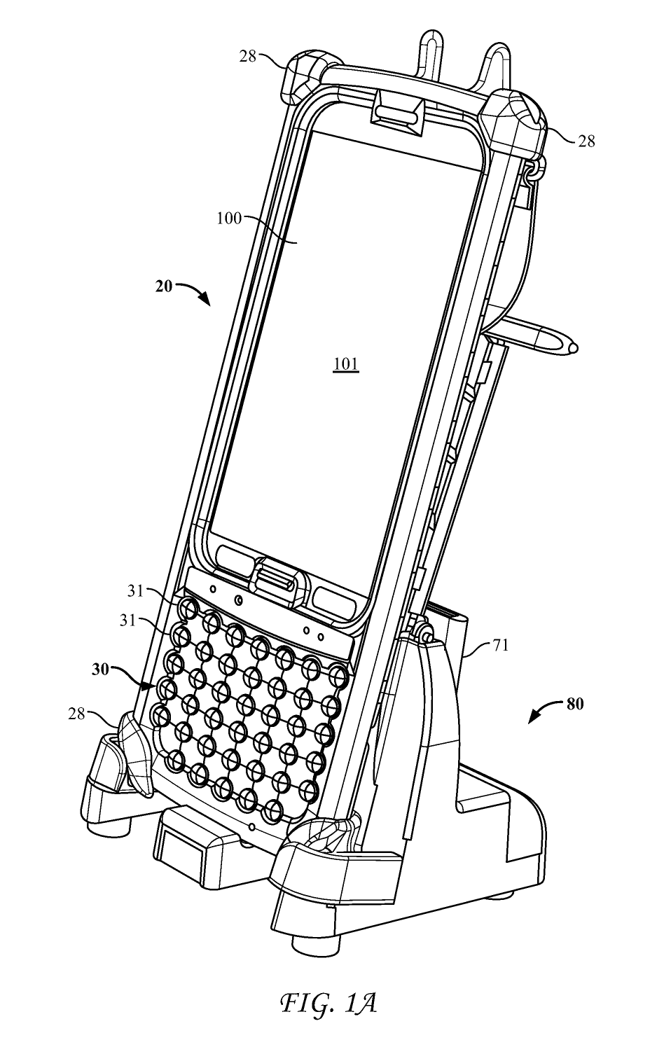

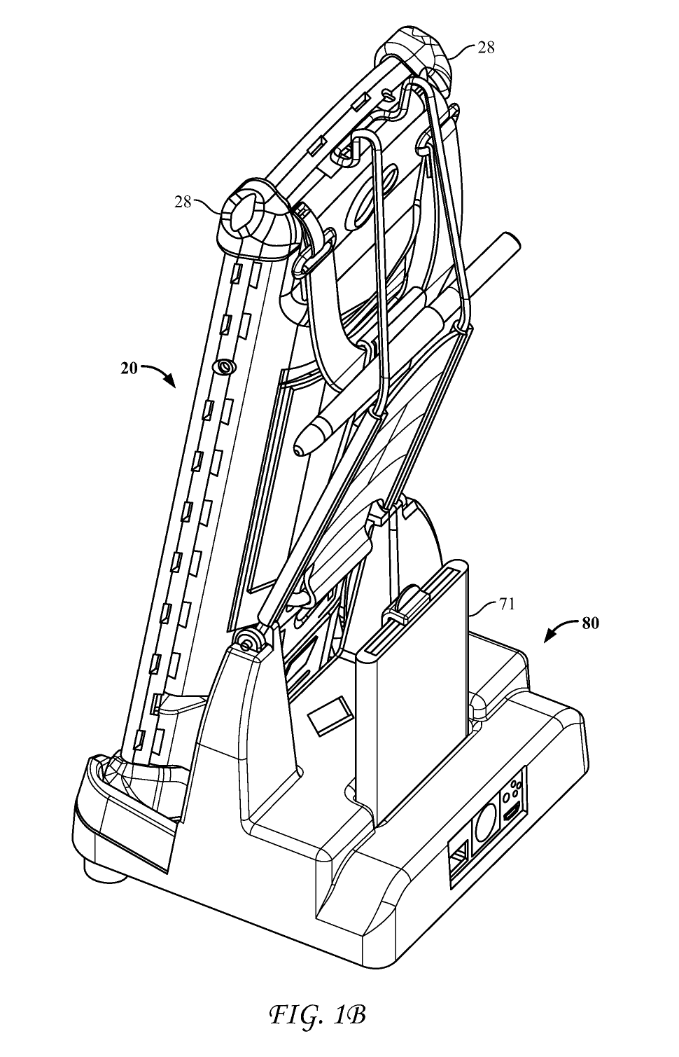

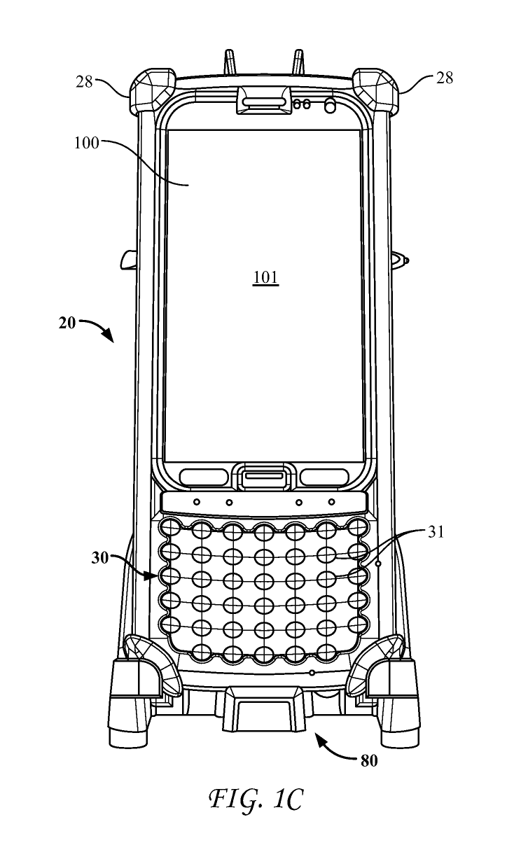

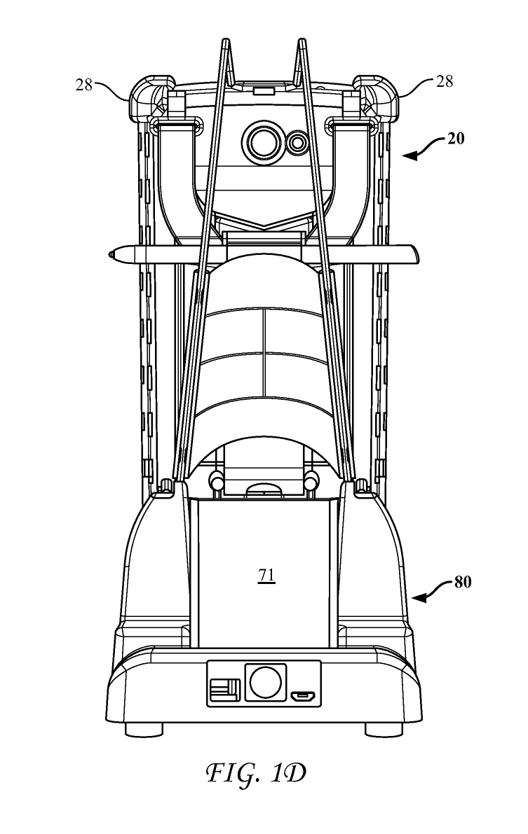

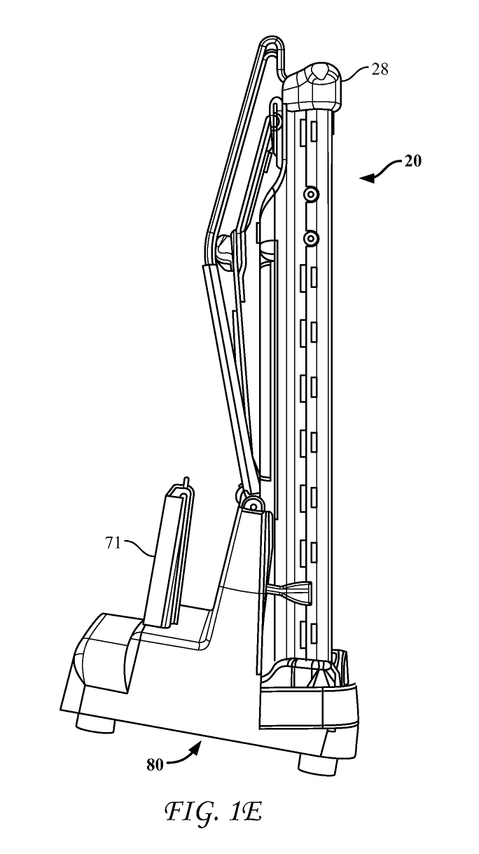

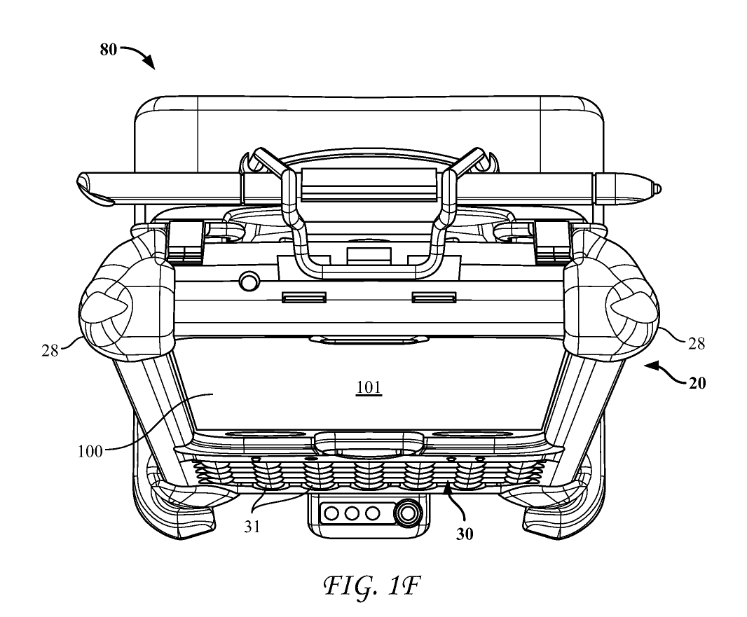

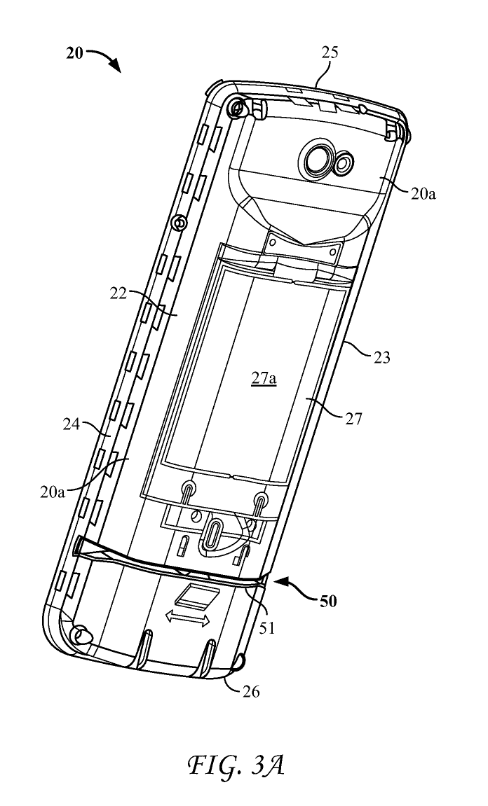

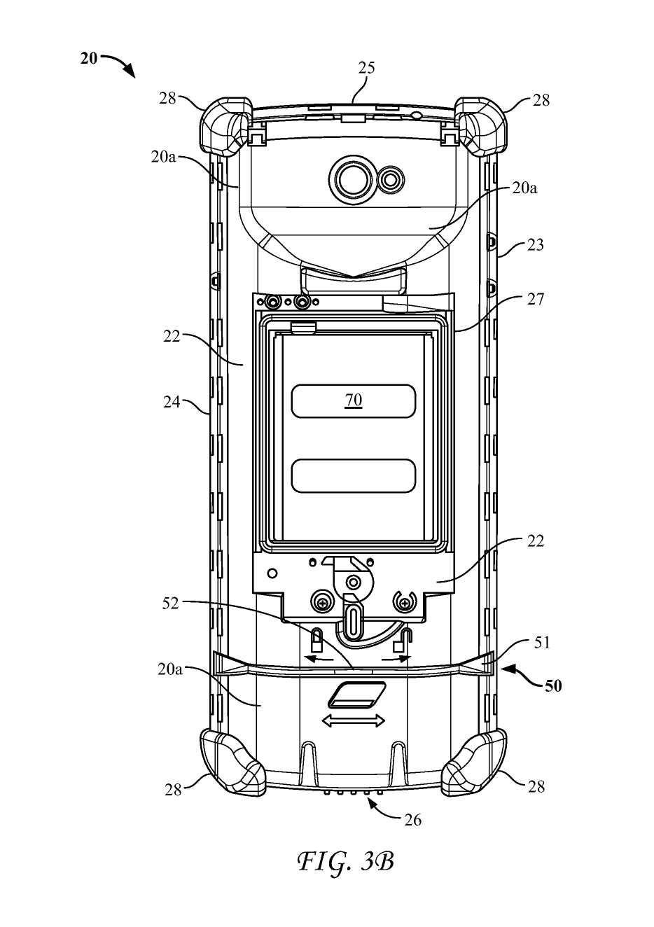

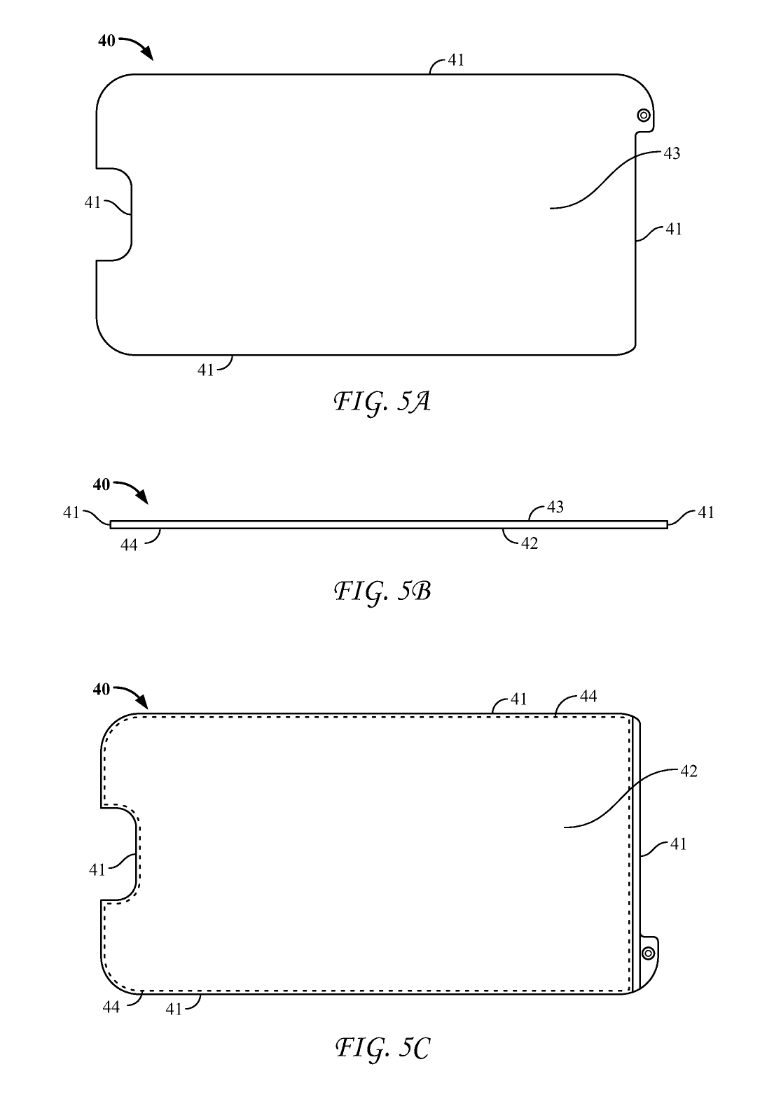

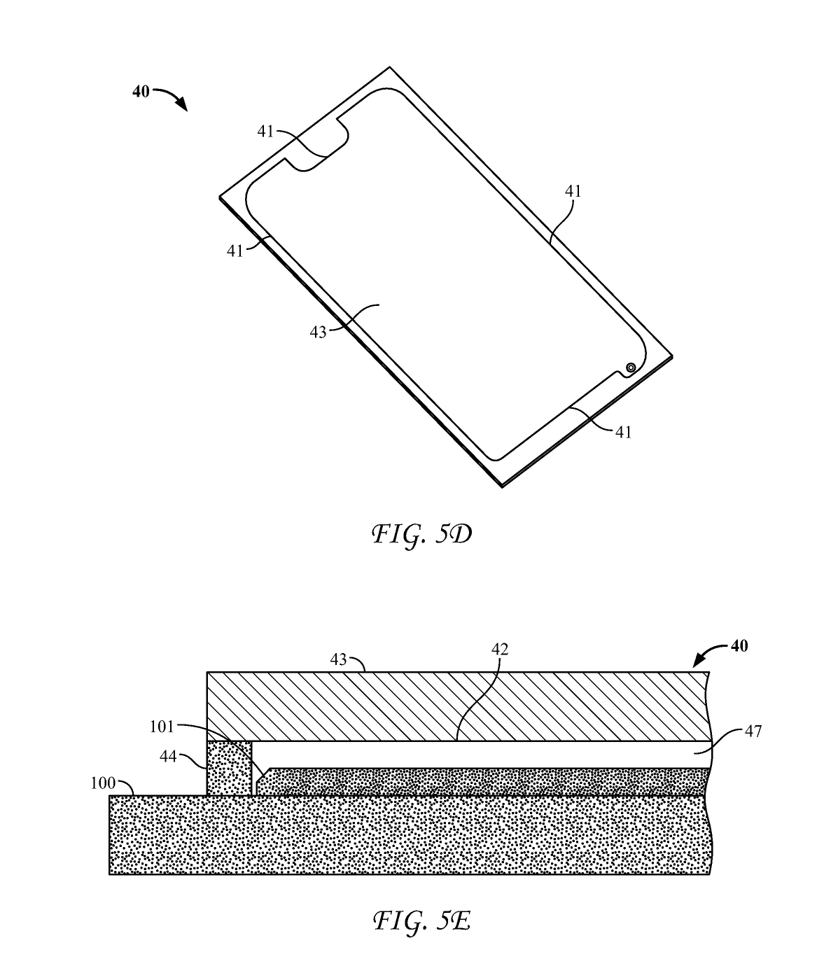

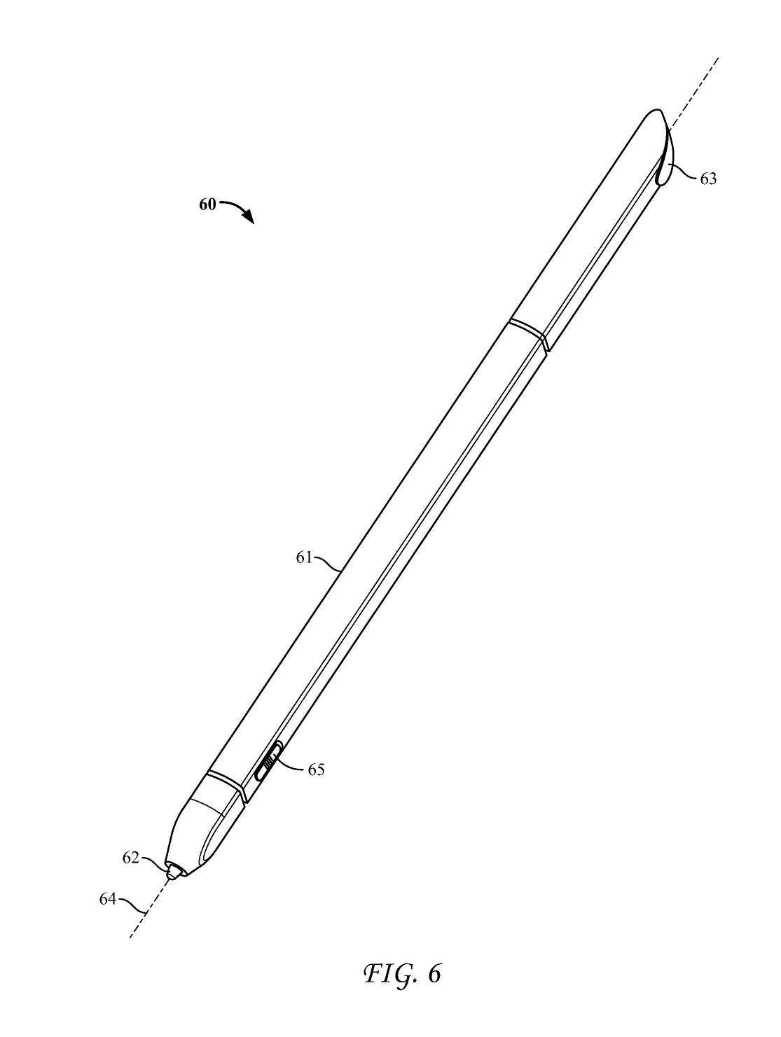

FIGS. 1A-1F depict an embodiment of a protective case (20) for an electronic device (100), such as a smart phone or tablet. Protective case (20) may be disposed in a docking station (80), as described in more detail below. The protective case (20) comprises a keyboard (30), a removable rain shield (40) (see FIGS. 5A-5D), a magnetic stripe reader (50) (see FIGS. 3A-3B), a stylus (60) (see FIG. 6), and a hot-swappable battery (70) (see FIG. 3B). Although the embodiments described in the present application disclose a protective case (20) configured for use with the electronic device (100), the protective case (20) may instead be configured for use with any portable electronic device capable of advanced computing capabilities. The electronic device (100) may further be an unaltered electronic device, such that the electronic device (100) has not been modified in any way subsequent to shipment by the manufacturer of the electronic device (100).

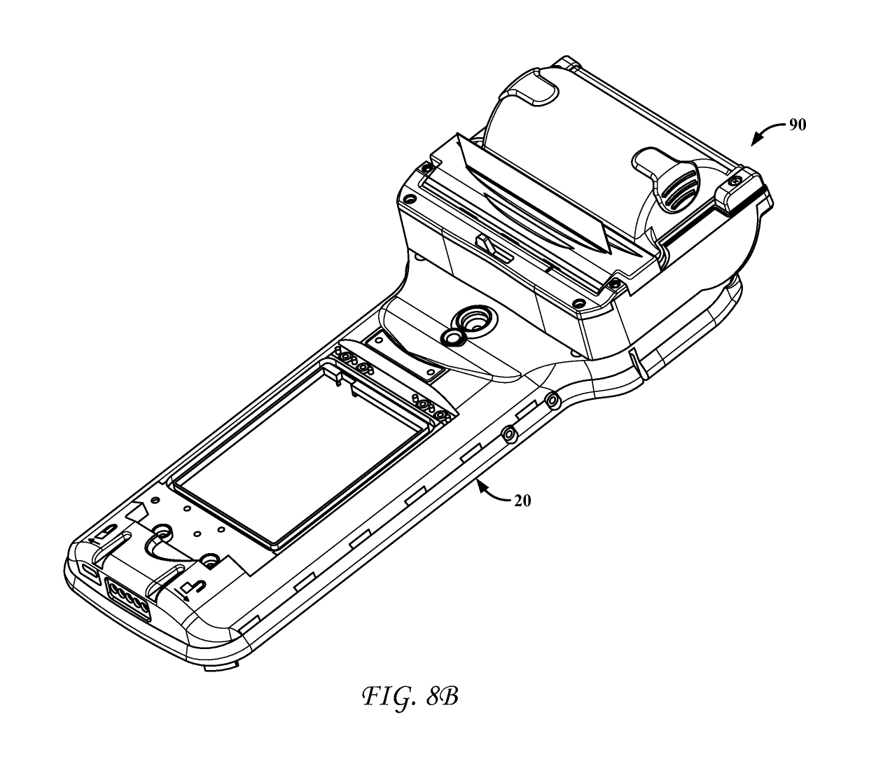

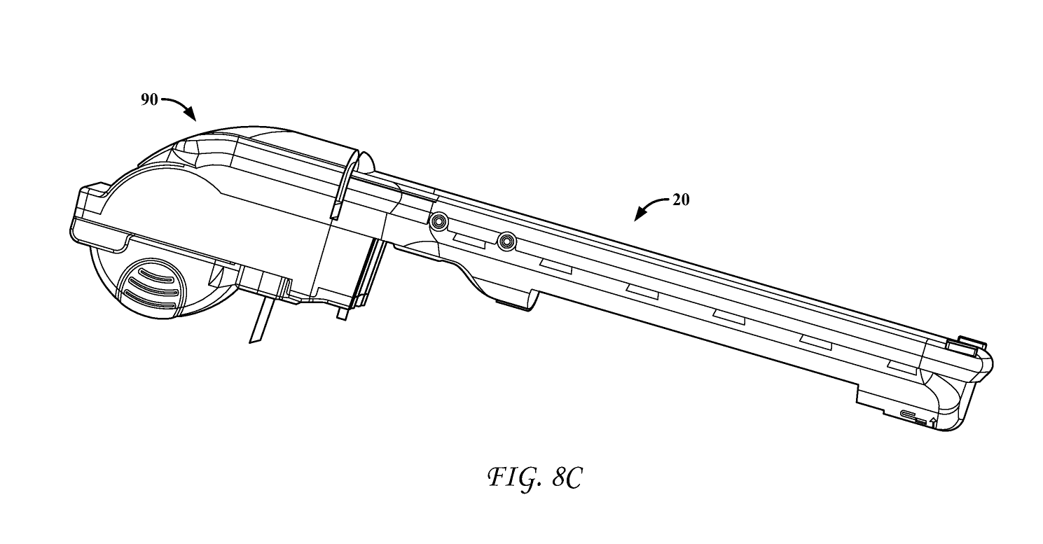

Additionally, the protective case (20) further includes at least one microprocessor, but may include as many as three microprocessors. The at least one microprocessor is disposed within the protective case (20) and is electronically configured to establish data communication between the electronic device (100) and the protective case (20). As will be described in more detail below, the at least one microprocessor is capable of, inter alia, instructing the power transfer capability associated with the hot-swappable battery (70) of the protective case (20). The at least one microprocessor may further be capable of electronically integrating the keyboard (30) and the magnetic stripe reader (50) with the electronic device (100), as well as integrating the functionality of other external devices—such as, for example printer (90), shown in FIGS. 8A-8C—connected to the protective case (20) via a USB or other similar connection (not shown).

### Protective Case

Referring now to FIGS. 1A, 2A, 2B, and 3A, the protective case (20) defines a recess (29) which is configured to fit electronic device (100). Within the recess (29), the protective case (20) further defines an integration plug (29a) configured to mate with a corresponding port on the electronic device (100) to provide an electronic connection. The integration plug (29a) may be disposed anywhere within the recess (29). The protective case (20) absorbs shocks from falls and also blocks water or moisture from entering the electronic device (100) by forming a protective barrier between the external environment and the electronic device (100). The protective case (20) is generally sized and shaped to substantially conform to the geometry of the electronic device (100), such that the protective case (20) will form a tight seal with the surface of the electronic device (100) when the electronic device (100) is disposed within the protective case (20) in an assembled configuration. The protective case (20) may further define gaskets (not pictured) that abut the electronic device (100) which help to form the tight seal. The protective case (20) may be designed from rigid, resilient materials configured to provide impact resistance, temperature resistance, and water resistance to the electronic device (100), such as, for example a thermoplastic polymer or a polycarbonate. The protective case (20) may be constructed to conform to the International Protection Rating system (“IP Code”, or simply “IP”), the protective case (20) may be manufactured so as to conform to the standards required for IP-65, IP-66, or IP-67.

With reference to FIGS. 1A and 2A-3A, the protective case (20) comprises a case body (20a), the case body (20a) defining a front surface (21) configured to be disposed adjacent to the screen (101) of the electronic device (100) and an opposed rear surface (22) configured to be disposed adjacent to a back panel (not shown) of the electronic device (100) when the electronic device (100) is in the assembled configuration. The front surface (21) is spaced from the rear surface (22) along a first direction. The case body (20a) also defines a top surface (25), and a bottom surface (26) spaced from the top surface (25) along a second direction that is substantially perpendicular to the first direction. The case body (20a) further defines a left side surface (23), and a right side surface (24) spaced from the left side surface (23) along a third direction that is substantially perpendicular to both the first and second directions. Collectively, the front surface (21), rear surface (22), left side surface (23), right side surface (24), top surface (25), and bottom surface (26) define the perimeter of the protective case (20). The protective case (20) also comprises a plurality of bumpers (28), which are disposed on the case body (20a) at any one of the intersections between the top and bottom surfaces (25/26) with the left side and right side surfaces (23/24). The plurality of bumpers (28) are generally located at the edges of the top and bottom surfaces (25/26) of the case body. The plurality of bumpers (28) may be formed of a material that has a greater modulus of elasticity than the remainder of the protective case (20), such that the plurality of bumpers (28) provide enhanced shock absorption to protect the electronic device (100) from falls or other sudden impacts.

Referring now to FIGS. 3A-3B, the rear surface (22) of the case body (20a) defines a battery compartment (27) configured to contain the hot-swappable battery (70). The rear surface (22) of the case body further includes a battery compartment door (27a) which may be configured in an open configuration—wherein the battery compartment (27) is partially or completely exposed—or a closed configuration—wherein the battery compartment door (27a) is removably fixated onto the case body (20a) and the battery compartment (27) is entirely hidden beneath the battery compartment door (27a).

### Hot Swappable Battery

The hot-swappable battery (70) may be a rechargeable Lithium Ion battery capable of storing 2500 mAh of power, although various power-storing capacities and other types of rechargeable batteries may be used. The hot-swappable battery (70) is removably attachable to the protective case (20) within the battery compartment (27) of the protective case (20), and as will be described in more detail below, the hot-swappable battery (70) is configured to provide auxiliary power to an internal rechargeable battery of the electronic device (100) when the at least one microprocessor causes the hot-swappable battery to divert its internally-stored power to the electronic device (100) and/or the internal rechargeable battery of the electronic device (100).

### Keyboard

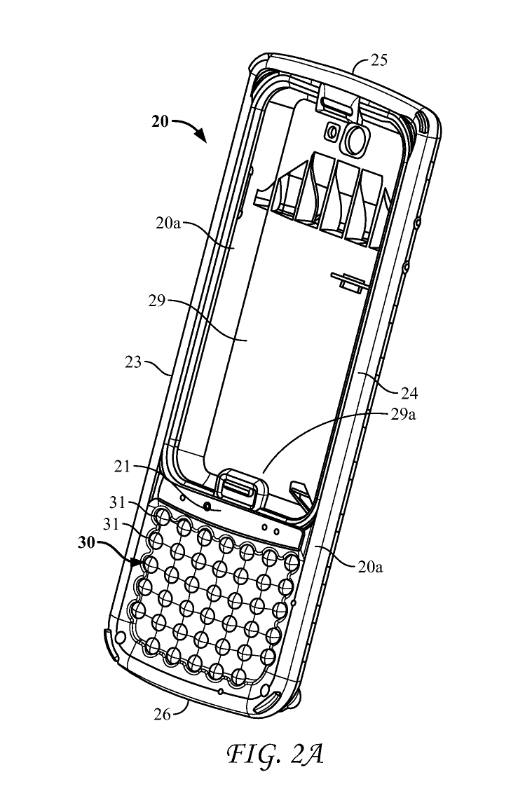

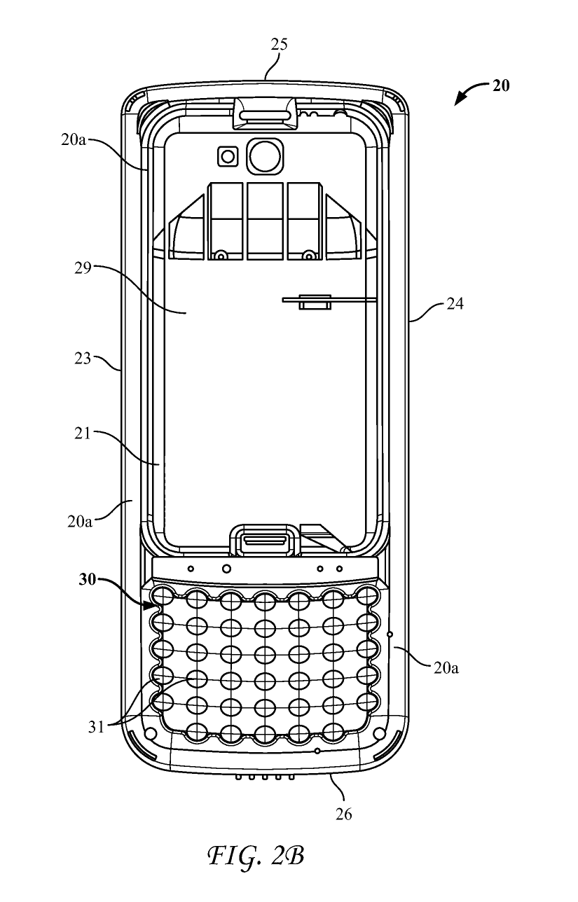

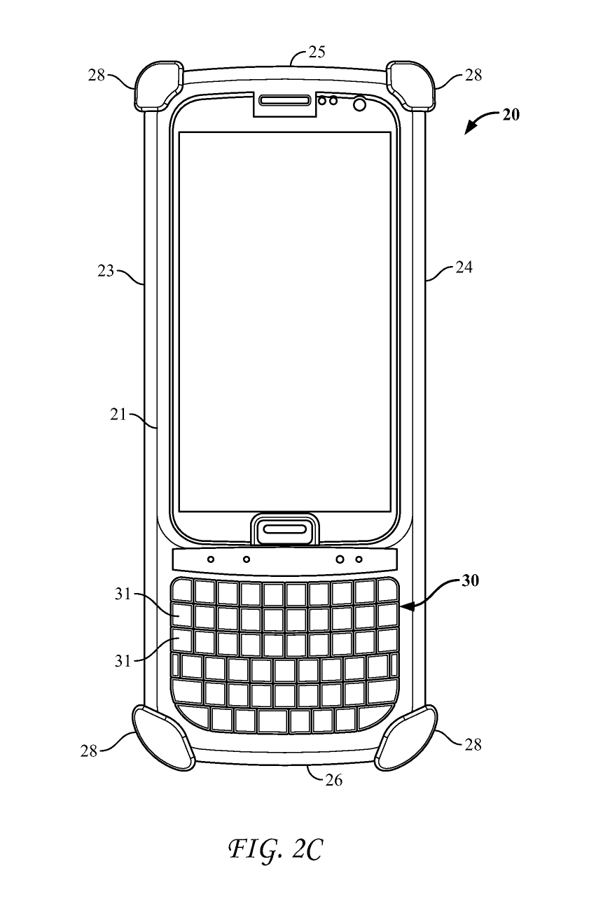

Referring now to FIGS. 1A, 1C, 2A, and 2B, the protective case (20) may further include keyboard (30) disposed on the front surface (21) of the case body (20a). The keyboard (30) may be disposed on the front surface (21) of the case body (20a) adjacent to the bottom surface (26), but the keyboard (30) may alternatively be disposed anywhere on the front surface (21) of the case body (20a). The keyboard (30) may be configured to be integral with the protective case (20). Alternatively, the protective case (20) may be constructed without a keyboard (30).

The keyboard (30) comprises a plurality of keys (31) which are arranged in a plurality of rows. The plurality of keys (31) correspond to alpha-numeric characters, such that a one of the plurality of keys (31) is configured to correspond to at least one distinct alpha-numeric character from any other one of the plurality of keys (31). As shown in FIG. 2C, the plurality of keys (31) may be arranged in a “Qwerty” style keyboard, although the plurality of keys (31) may alternatively be arranged in any logical order. The keyboard (30) is configured to communicate with the electronic device (100) when a user depresses any one of the plurality of keys (31) corresponding to alpha-numeric characters in the same manner as a software-based computer that would be displayed on the screen (101) of the electronic device (100). The user may configure the electronic device (100) as desired to disable or enable the software-based keyboard on the screen (101) in preference for the keyboard (30) of the protective case (20). Thus, the keyboard (30) may assume the role of the primary keyboard for use with the electronic device (100).

The keyboard (30) may also be configured to provide back-lighting to the plurality of keys (31). When the plurality of keys (31) are in a backlit configuration, they are illuminated with light originating from behind the keyboard (30) from within the protective case (20). When the keyboard (30) is in the backlit configuration, the user may more easily identify a desired one of the plurality of keys (31) when there is little to no environmental light near the user.

### Rain Shield

Referring now to FIGS. 5A-5E, rain shield (40) is configured to cover a screen (101) of the electronic device (100) in an installed configuration. The rain shield (40) comprises outer edges (41) that define the perimeter of the rain shield (40). The rain shield (40) defines a rain shield bottom surface (42) that faces the screen (101) of the electronic device (100) in the installed configuration, and an opposed rain shield top surface (43) that opposes the rain shield bottom surface (42). The rain shield (40) is sized and shaped to fit directly above the screen (101) of the electronic device (100) when the rain shield (40) is in the installed configuration. More specifically, the surface geometry and surface area of the rain shield (40) are configured to closely resemble the respective surface geometry and surface area of the screen (101) of the electronic device (100), such that the outer edges (41) extend beyond each respective edge of the screen (101) so as to completely cover the screen (101) in the installed configuration.

The rain shield (40) is a thin, transparent, textured membrane capable of providing anti-glare and anti-gloss properties to reduce the reflectivity of environmental light. The rain shield (40) may comprise a hard-coated polyester film, such as Autoflex EBG-5 Polyester disposed on the rain shield top surface (43). The polyester film may have a thickness that is in the range of about 0.005-0.015 inches, or specifically 0.010 inches.

With specific reference to FIG. 5C, the rain shield (40) further includes an adhesive layer (44) which is disposed near the outer edges (41) on the rain shield bottom surface (42). The adhesive layer (44) is configured to fixate the rain shield (40) with respect to the screen (101) of the electronic device (100) so as to limit translation of the rain shield (40) with respect to the electronic device (100). The adhesive layer (44) has a thickness that is in the range of about 0.040-0.050 inches, or specifically 0.045 inches, and is configured to allow the rain shield (40) to be removably disposed on the electronic device (100). The adhesive layer may be designed from a water-resistant adhesive material, such as 3M™ black adhesive part number VHB5952.

With reference to FIG. 5E, when the rain shield (40) is disposed on screen (101), the adhesive layer (44) is configured to abut the electronic device (100) just outside the edges of the screen (101) so as to form a complete seal around the screen (101). Due to the placement of the adhesive layer (44) at the outer edges (41) of the rain shield bottom surface (42), when the rain shield (40) is in the installed configuration, the rain shield bottom surface (42) is positioned above, but does not directly contact, the screen (101) of the electronic device (100) such that a void (47) is disposed between the screen (101) and the rain shield bottom surface (42). In other words, the void (47) is partially defined by the thickness of the adhesive layer (44). The void (47) permits selectivity with respect to touch-based interactivity with the screen (101) of the electronic device (100) in that, when the rain shield (40) is in the installed configuration, only certain forces (as elaborated below) that come into contact with the rain shield top surface (43) will flex the rain shield (40) sufficiently such that the rain shield bottom surface (42) penetrates the void (47) and thereby makes physical contact with the screen (101) of the electronic device (100).

Rain shield (40) retains a substantially rigid form when weak forces are imparted to the rain shield top surface (43), such that the rain shield bottom surface (42) does not penetrate the void (47) so as to make physical contact with the screen (101) of the electronic device (100). For example, weak forces on the rain shield may result from wind, rain, sleet, snow, or an insect. When strong forces are imparted to the rain shield, the rain shield bottom surface (42) penetrates the void (47) so as to make physical contact with the screen (101) of the electronic device (100) so as to affect a response from the electronic device (100). Examples of strong forces may include a finger press by the user or engagement with the stylus (60) (illustrated in FIG. 6).

### Magnetic Stripe Reader

Referring now to FIGS. 3A-3B, the protective case (20) may further include a magnetic stripe reader (50), generally disposed on the rear surface (22) of the case body (20a) adjacent to the bottom surface (26). The magnetic stripe reader (50) may be configured to be integral with the protective case (20). The magnetic stripe reader (50) defines a card slot (51) and a magnetic reading head (52) that is disposed within the card slot (51). The magnetic reading head (52) is configured to extract magnetically stored data contained within magnetic stripe cards, such as credit cards, when the magnetic stripe cards are translated through the card slot (51) and across the magnetic reading head (52). The magnetic stripe reader (50) is further configured to electronically transfer the extracted magnetically stored data to the electronic device (100) for electronic storage, data processing, or any other desired use by the user with the magnetically stored data. The magnetic reading head (52) is configured to read three tracks of data as they are stored within a typical magnetic stripe card. The magnetic reading head (52) is further configured to permit a magnetic stripe card to be translated (i.e., swiped) within the card slot (51) in the third direction, either from the left side surface (23) to the right side surface (24), or alternatively from the right side surface (24) to the left side surface (23). In other words, the magnetic reading head (52) operates with bi-directional card-swiping capability.

The transfer of magnetically stored data from the magnetic stripe reader (50) to the electronic device (100) may be accomplished via a physical (i.e., wired) connection, such as with Universal Serial Bus (USB) ports, wirelessly via Bluetooth, or through other data transfer mechanisms. In an alternative embodiment, the magnetic stripe reader (50) may also be configured as a smart-card reader, adapted and configured to extract stored data from within a smart-card chip on credit card or similar card.

### Stylus

Referring now to FIG. 6, a stylus (60) may be used in conjunction with the protective case (20). The stylus (60) may be in the shape of a writing utensil, the stylus (60) having a stylus body (61) that is elongate along a central axis (64) and that extends from a stylus tip (62) to a stylus head (63). The stylus tip (62) is configured to engage with the screen (101) of the electronic device (100) or the rain shield top surface (43) when the rain shield (40) is in the installed configuration. The stylus tip (62) may be pressure-sensitive, such that the electronic device (100), by communicating with the stylus (60), will recognize and discern various levels of pressure exerted by the stylus tip (62) on the screen (101). The stylus (60) may include a shift button (65) that is disposed on the stylus body (61), the shift button (65) being capable of being depressed by the user as desired. The shift button (65) is configured to enable alternative functionality when depressed by the user prior to engaging the stylus tip (62) with the screen (101) of the electronic device (100).

### Docking Station

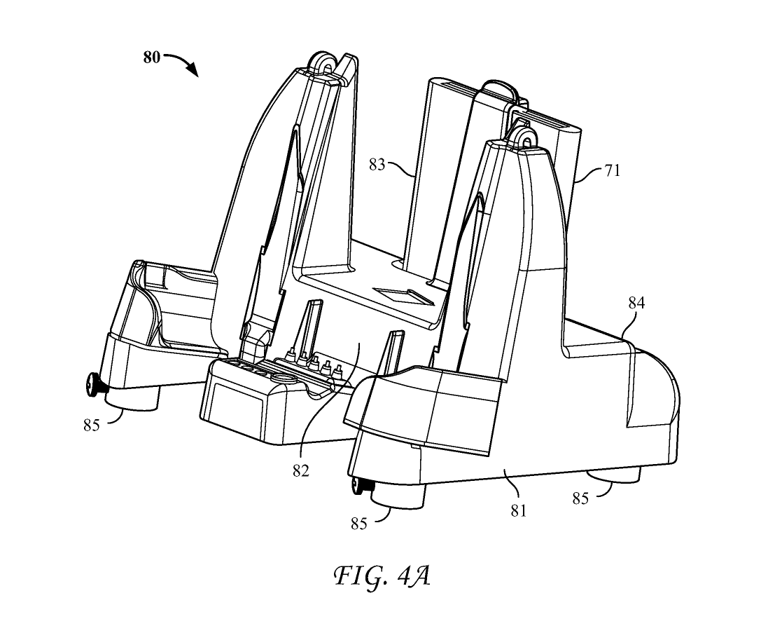

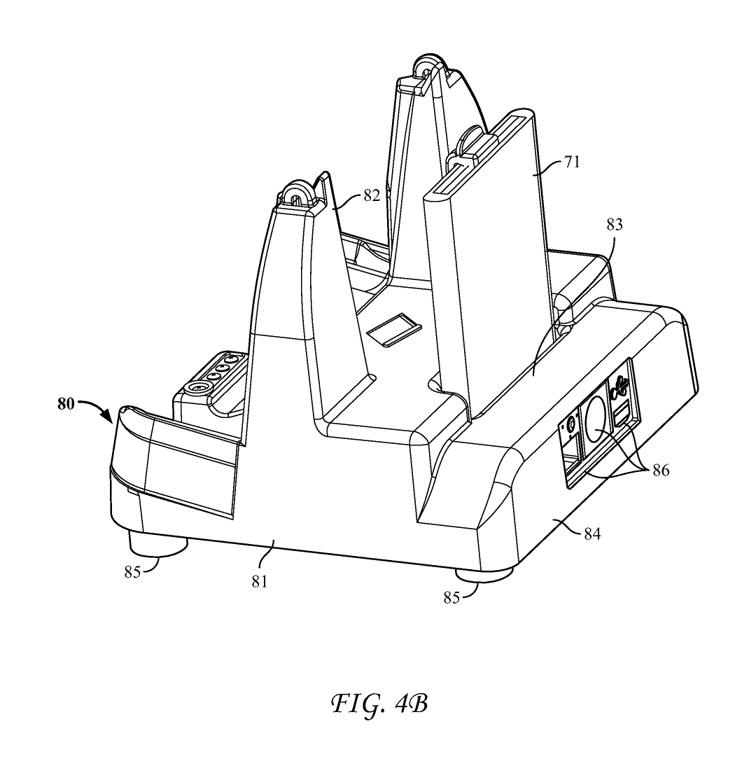

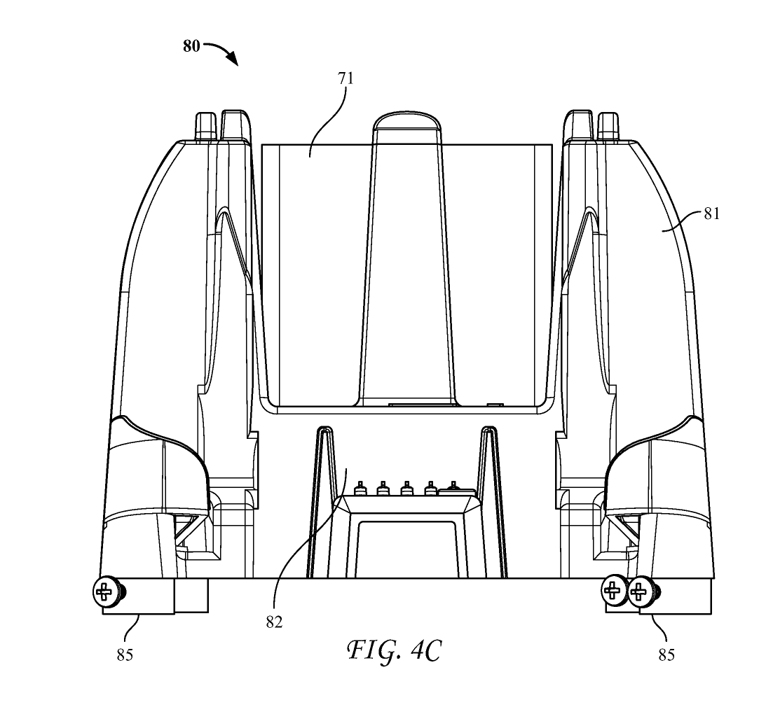

Referring to FIGS. 1A-1F and 4A-4C, a docking station (80) and a second hot-swappable battery (71) may be used in conjunction with the protective case (20). The second hot-swappable battery (71) is substantially similar in size, shape, and function to the hot-swappable battery (70) described above, and the second hot-swappable battery (71) may likewise be configured to be disposed in the battery compartment (27) of the protective case (20). In one aspect, the second hot-swappable battery (71) may alternatively be referred to as a third battery. As shown in FIGS. 4A-4C, the second hot-swappable battery (71) may reside within the docking station (80), as will be explained in greater detail below. The docking station (80) comprises a dock body (81), a docking portion (82), a battery charging portion (83), and a back dock portion (84). The docking station (80) may be powered by an external power supply, such as an A/C outlet, a car charger port, or any power supply capable of delivering around 2 Amps of power.

Referring now to FIGS. 4A-4D, the dock body (81) may define dock legs (85) that extend outwardly from the dock body (81). The dock legs (85) are configured to abut a flat, substantially planar surface so as to situate the docking station (80) on the surface. The docking portion (82) is configured to electronically and physically engage with the electronic device (100) when it is disposed within the protective case (20) in the assembled configuration so as to define a docked configuration. The battery charging portion (83) is configured to mate with either the hot-swappable battery (70) or the second hot-swappable battery (71) so as to provide power to the battery via the external power supply in the manner described above. When in the docked configuration, the docking station (80) may provide additional power to an internal rechargeable battery (not pictured) of the electronic device (100) as well as to the hot-swappable battery (70) or the second hot-swappable battery (71) when the hot-swappable battery (70) or second hot-swappable battery (71) is disposed within the battery compartment (27) of the protective case (20), as well as to the hot-swappable battery (70) or the second hot-swappable battery (71) when the hot-swappable battery (70) or second hot-swappable battery (71) is disposed in the battery charging portion (83). Additionally, while in the docked configuration, the docking portion (82) may engage with at least one USB port (not pictured) of the electronic device (100) so as to enable data synchronization with any wired or wireless network. For example, the docking station (80) may enable the electronic device (100) to synchronize data with “the cloud”, while the electronic device (100)—in the assembled configuration with the protective case (20)—is in the docked configuration. The back dock portion (84) may contain any number of ports (86) capable of physical attachment to a wire or cable, such as a power cable, USB cable, or micro-USB cable.

### Carrier Case

A carrier case (not pictured) may further be used with the protective case (20). The carrier case may be made of ballistic nylon. The carrier case is designed and configured to encapsulate the protective case (20) and the electronic device (100) when the electronic device (100) is in the assembled configuration. The carrier case further comprises an attachment component configured to physically attach the carrier case to the user of the protective case (20). The attachment component may be a belt clip or a Velcro® attachment mechanism, or another type of attachment mechanism. The carrier case further includes a plurality of pockets, the pockets being configured to contain at least the stylus (60), second hot-swappable battery (71) or hot-swappable battery (70), and a secondary rain shield.

### Hand Strap

The protective case (20) may further include a hand-strap (not pictured) disposed on the rear surface (22) of the case body (20a). The hand-strap may define an elastic portion that is configured for removable attachment to a user's hand. The hand-strap may be designed from elastic materials, such that the user of the protective case (20) may secure the protective case (20) to their hand for ease of transport. Alternatively or in addition, the hand strap may further define a belt clip or similar attachment mechanisms which would enable a user to transport the protective case (20) on, for example, the user's belt, when it is in the assembled configuration.

### Printer

Referring now to FIGS. 8A-8C, the protective case (20) may further include a printer (90), such as a thermal printer. The printer (90) is configured to be disposed on the rear surface (22) of the case body (20a). The printer (90) may be disposed adjacent to the top surface (25) on the rear surface (22) of the case body (20a). Alternatively, the printer may be integral with the protective case (20). The printer (90) may be any digital printer capable of producing printed images. For example, a thermal printer may selectively heat thermal paper, contained on a spool within the thermal printer, when the thermal paper passes over a thermal print head. The printer (90) is sized and shaped to generally conform to the dimensions of the protective case (20) such that the printer (90) will extend along the third direction between the left and right side surfaces (23/24) when the printer (90) is disposed on the protective case (20). The printer (90) is configured to be electronically connectable to the electronic device (100) such that the electronic device can generate printing commands to be received and fulfilled by the printer (90). In other words, the electronic device (100) may communicate directly with the printer (90) such that the printer (90), upon receiving a corresponding instruction from the electronic device (100), will cause a requested printable item to be printed by the printer (90). The printer (90) may be electronically connectable to the electronic device (100) by, for example, a USB wire or by wireless signals. The at least one microprocessor may be configured to establish data communication between the electronic device (100) and the printer (90).

### Hot-Swappable Battery

A further feature of the protective case (20) is a power transfer capability using the hot-swappable battery (70). As introduced above, the hot-swappable battery (70) is configured to provide power to the electronic device (100) by diverting its internally-stored power to either the electronic device (100), the internal rechargeable battery of the electronic device (100)—or both simultaneously—only when the hot-swappable battery (70) is disposed within the battery compartment (27) of the protective case (20) and the battery compartment door (27a) is in the closed configuration. When these conditions have been met, the hot-swappable battery (70) is considered “installed”.

The hot-swappable battery (70) is capable of performing the same power supply functions as the second hot-swappable battery (71). In that manner, the second hot-swappable battery (71) may be thought of as a tertiary battery. Although the power transfer capability, described below, refers to use of the hot-swappable battery (70), an identical power transfer functionality may likewise be carried out by the second hot-swappable battery (71) when the second hot-swappable battery (71) is installed.

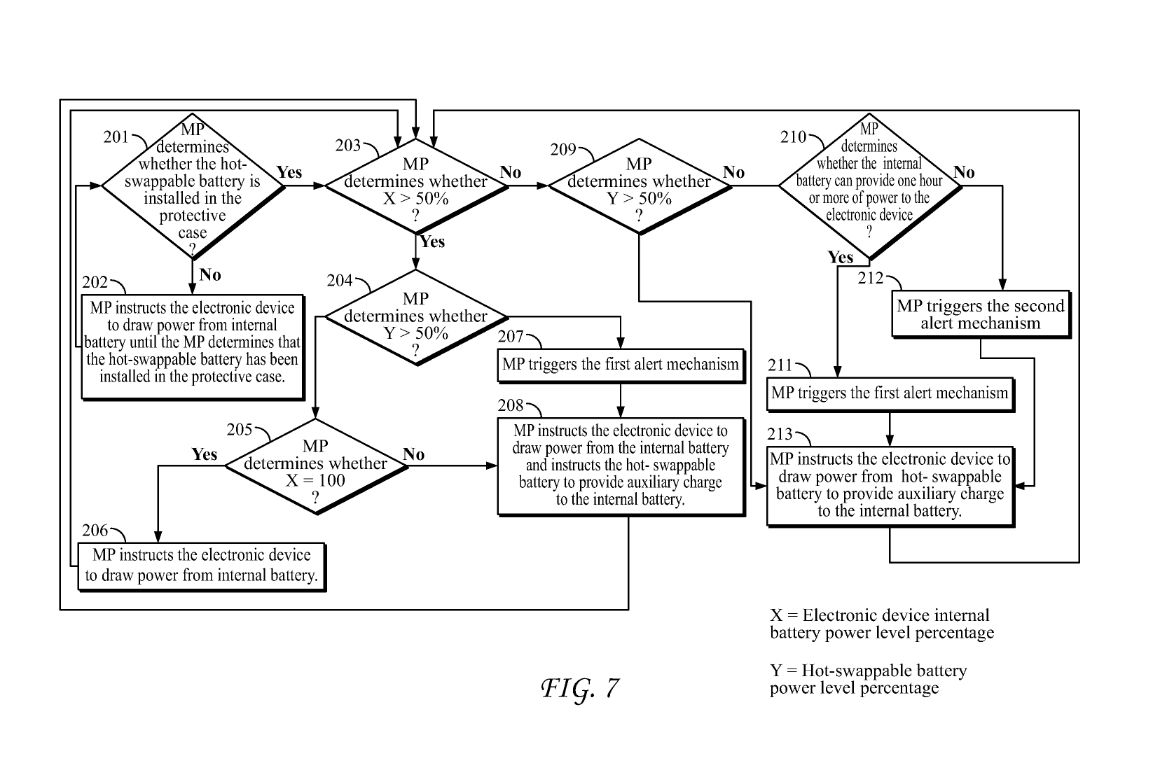

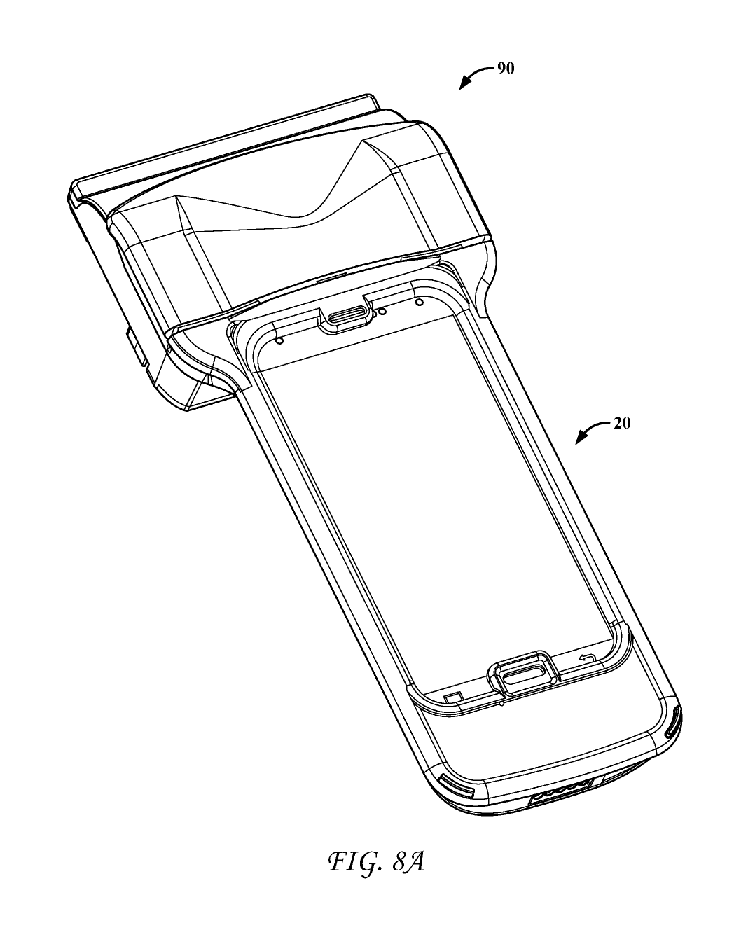

As will be described in more detail below, the at least one microprocessor disposed within the protective case (20) communicates with the hot-swappable battery (70) installed to initiate a charging cycle, characterized by depleting stored power from the hot-swappable battery (70), and supplying said energy to the internal battery of the electronic device (100) or directly to the electronic device (100). When the hot-swappable battery (70) is installed but the user subsequently opens the battery compartment door (27a), the at least one microprocessor will immediately cause (or continue to cause) the electronic device (100) to be powered by the internal battery of the electronic device (100) unless and until the hot-swappable battery (70) or second hot-swappable battery (71) is once again installed—and hence, the battery compartment door (27a) is returned to the closed configuration. Referring to FIG. 7, at step 201, the at least one microprocessor determines whether the hot-swappable battery (70) is installed. When the hot-swappable battery (70) is not installed as in step 202, the at least one microprocessor will instruct the electronic device (100) to be powered exclusively by the internal battery of the electronic device (100) until such time as the at least one microprocessor determines that the hot-swappable battery (70) has been installed. When the at least one microprocessor determines that the hot-swappable battery (70) has been installed, the at least one microprocessor will then determine the power level of the internal rechargeable battery of the electronic device (100).

In a fully charged configuration, the hot-swappable battery (70) and the internal battery of the electronic device (100) are charged to their fullest capacity, or 100%. In the fully charged configuration, the at least one microprocessor will follow steps 203, 204, and 205, and 206. At step 206, the at least one microprocessor will instruct the electronic device (100) to draw power exclusively from the internal battery of the electronic device (100). At step 205, when the internal battery power level drops below 100%, as at step 208, the at least one microprocessor will instruct the electronic device (100) to draw power exclusively from the internal battery of the electronic device (100). Additionally at step 208, the at least one microprocessor will instruct the hot-swappable battery (70) to initiate a charging cycle, the charging cycle being defined by the hot-swappable battery (70) diverting its stored power to the internal battery of the electronic device (100) as at step 208.

In a first partially charged configuration, the internal battery of the electronic device (100) contains at least 50% of its total power capacity and the hot-swappable battery (70) contains between 51-99% of its total power capacity. In the first partially charged configuration, the at least one microprocessor will follow steps 203, 204, 205, and 208. Thus, at step 208, the at least one microprocessor will instruct the electronic device (100) to draw power exclusively from the internal battery, and it will also instruct it to initiate the charging cycle, as described above. Departing from the first partially charged configuration, if the internal battery of the electronic device (100) contains 50% or less of its total power capacity, continuing to step 207, the at least one microprocessor will trigger a first alert mechanism, signifying to the user that the hot-swappable battery (70) should be replaced. The first alert mechanism may be in the form of an illuminated single-colored warning LED, operably connected to the at least one microprocessor, located on the protective case (20), although other forms of alert mechanisms may be employed, such as an audible sound, a pop-up alert on the electronic device (100), or any other similar alert mechanism. In addition to the first alert mechanism, at step 208, the at least one microprocessor will further instruct the electronic device (100) to draw power exclusively from the internal battery, and it will also instruct the electronic device (100) to initiate the charging cycle, as described above.

In a second partially charged configuration, the internal battery of the electronic device (100) contains less than 50% of its total power capacity and hot-swappable battery (70) contains between greater than 50% of its total power capacity. In the second partially charged configuration, the at least one microprocessor will follow steps 203, 209, and 213. Thus, at step 213, the at least one microprocessor will cause the electronic device (100) to draw power exclusively from the hot-swappable battery (70), and it will also initiate the charging cycle, as described above. Departing from the second partially charged configuration, if the at least one microprocessor detects that the hot-swappable battery (70) contains 50% or less of its full power capacity, the at least one microprocessor, at step 210, will further calculate whether the internal battery of the electronic device (100) has depleted to a power level which would provide only enough power to the electronic device (100) to keep it functioning for one hour or less. If the at least one microprocessor determines that the internal battery can provide at least one hour or more of power to the electronic device (100), indicated at step 211, the at least one microprocessor will trigger the first alert mechanism, as described above. Alternatively, if the at least one microprocessor determines that the internal battery cannot provide at least one hour of power to the electronic device (100), indicated at step 212, the at least one microprocessor will trigger a second alert mechanism that is distinguishable from the first alert mechanism. The second alert mechanism may be in the form of an illuminated multicolored warning LED, operably connected to the at least one microprocessor, located on the protective case (20), although other forms of alert mechanisms may be employed, such as an audible sound, a pop-up alert on the electronic device (100), or any other similar alert mechanism. In addition either the first or second alert mechanisms, at step 213, the at least one microprocessor will further instruct the electronic device (100) to draw power exclusively from the hot-swappable battery (70), and it will also instruct the electronic device (100) to initiate the charging cycle, as described above.

The embodiments described in connection with the illustrated embodiments have been presented by way of illustration, and the present disclosure is therefore not intended to be limited to the disclosed embodiments. For instance, it is envisioned that certain components may not be included on certain embodiments of the protective case (20). Additionally, it is contemplated that additional components included in this description may be incorporated into future embodiments of the protective case (20). The structure and features of each the embodiments described above can be applied to the other embodiments described herein, unless otherwise indicated. Accordingly, the present disclosure is intended to encompass other modifications and alternative arrangements.

What is claimed is:

1. A protective case configured to house an electronic device, the protective case comprising:
a case body comprising a first material having a first modulus of elasticity, the case body defining a recess which is configured to house the electronic device, the case body further defining:
a front surface configured to be disposed adjacent to a screen of the electronic device when the electronic device is disposed in the recess;
a rear surface opposed from the front surface, the rear surface configured to be disposed adjacent to a back panel of the electronic device when the electronic device is disposed in the recess, the rear portion defining a battery compartment;
a left side surface disposed between the front and rear surfaces;
a right side surface spaced from the left side surface;
a top surface; and
a bottom surface spaced from the top surface;
at least two hot-swappable batteries, wherein a first hot-swappable battery of the at least two hot-swappable batteries is removably attached to the battery compartment and replaceable by a second hot-swappable battery of the at least two hot-swappable batteries, such that when the first hot-swappable battery is removed from the battery compartment and replaced by the second hot-swappable battery, the protective case is configured such that the electronic device is powered by an internal battery; and
at least one microprocessor disposed within the protective case, the at least one microprocessor configured to establish data communication between the electronic device and any of the at least two hot-swappable batteries.

2. The protective case of claim 1, further comprising a plurality of bumpers disposed on the case body near at least one of the intersections between the top and bottom surfaces with the left side and right side surfaces, the plurality of bumpers comprising a second material having a second modulus of elasticity;

3. The protective case of claim 1, further comprising a rain shield configured to cover the screen of the electronic device, the rain shield configured so as to define a void between a bottom surface of the rain shield and the screen of the electronic device.

4. The protective case of claim 3, wherein the rain shield retains a substantially rigid form when weak forces are imparted to the rain shield top surface, and wherein the rain shield flexes toward the bottom surface when strong forces are imparted to the rain shield top surface, such that the rain shield bottom surface penetrates the void so as to make physical contact with the screen of the electronic device.

5. The protective case of claim 1, further comprising a keyboard disposed on the front surface of the case body, the keyboard comprising a plurality of keys, each one of the plurality of keys corresponding to at least one alpha-numeric character.

6. The protective case of claim 5, wherein the keyboard is configured to provide back-lighting to the plurality of keys vis-à-vis illuminating LED lights disposed beneath each one of the plurality of keys.

7. The protective case of claim 5, wherein the at least one microprocessor is configured to establish data communication between the electronic device and the keyboard.

8. The protective case of claim 1, further comprising a stylus having a stylus body that is elongate along a central axis, the stylus body extending from a pressure-sensitive stylus tip to a stylus head, the pressure-sensitive stylus tip being configured to engage with the screen of the electronic device, the stylus body comprising a shift button configured to enable alternate functionality when the pressure-sensitive stylus tip engages with the screen of the electronic device.

9. The protective case of claim 8, wherein the stylus is configured to wirelessly communicate with the electronic device, such that the pressure-sensitive stylus tip may recognize and discern various levels of pressure between the pressure-sensitive stylus tip and the screen of the electronic device when the pressure-sensitive stylus tip engages therewith.

10. A docking station including the protective case of claim 1, the docking station comprises a dock body, a docking portion, a battery charging portion, and a back dock portion, the docking portion being configured to electronically and physically engage with the electronic device when the electronic device is disposed within the protective case to define a docked configuration, the battery charging portion being configured to mate with either one of the at least two hot-swappable batteries so as to provide power to the battery via an external power supply.

11. The protective case of claim 1, further comprising a printer disposed on the rear surface of the case body, the printer being electronically connectable to the electronic device such that the electronic device can generate printing commands to be received and fulfilled by the printer.

12. The protective case of claim 11, wherein the printer is integral with the case body.

13. The protective case of claim 11, wherein the at least one microprocessor is configured to establish data communication between the electronic device and the printer.

14. A carrier case including the protective case of claim 3, wherein the carrier case comprises ballistic nylon, the carrier case being designed and configured to encapsulate the protective case and the electronic device when the electronic device is disposed in the protective case, the carrier case further comprising an attachment component configured to mount the carrier case to a user of the protective case, the carrier case further comprising a plurality of pockets, the pockets configured to contain at least the stylus, at least one of the at least two hot swappable batteries, and the rain shield.

15. The protective case of claim 1, further comprising a hand-strap disposed on the rear portion of the case body, the hand strap defining an elastic portion that is configured to permit removable attachment of the protective case to a user's hand.

16. The protective case of claim 1, further comprising a magnetic stripe reader disposed on the rear surface of the case body, the magnetic stripe reader defining a card slot and a magnetic reading head that is disposed within the card slot, the magnetic reading head configured to extract magnetically stored data contained within magnetic stripe cards.

17. The protective case of claim 16, wherein the magnetic stripe reader is further configured to read smart card chips.

18. The protective case of claim 16, wherein the at least one microprocessor is configured to establish data communication between the electronic device and the magnetic stripe reader.

19. A rain shield configured for use on a screen of an electronic device, the rain shield comprising a film disposed on a top surface of the rain shield and an adhesive layer disposed on an opposed bottom surface of the rain shield,
wherein the adhesive layer is configured to abut the electronic device in an installed configuration so as to fixate the positioning of the rain shield with respect to the surface of the electronic device so as to limit translation of the rain shield,
wherein, in the installed configuration, the bottom surface faces the screen of the electronic device so as to define a void therebetween, the void being partially defined by the adhesive layer, the rain shield retaining a substantially rigid form when weak forces are imparted to the top surface such that the bottom surface does not penetrate the void, and the rain shield flexing toward the bottom surface when strong forces are imparted to the rain shield top surface, such that the rain shield bottom surface penetrates the void so as to make physical contact with the screen of the electronic device.

20. The rain shield of claim 19, wherein the film comprises Autoflex EBG-5 Polyester.

21. The rain shield of claim 19, wherein the adhesive layer has a thickness of about 0.045 inches.

22. A kit configured for use with an electronic device, the kit comprising:
a protective case defining a case body, the protective case being configured to retain the electronic device, the case body defining a front surface, an opposed rear surface spaced from the front surface in a first direction, a bottom surface disposed between the front and rear surfaces, and a top surface disposed between the front and rear surfaces and spaced from the bottom surface in a second direction, the second direction being substantially perpendicular to the first direction, the rear surface further containing a battery compartment;
a keyboard disposed on the front surface of the case body adjacent to the bottom surface, the keyboard comprising a plurality of keys, each one of the plurality of keys corresponding to at least one alpha-numeric character;
a magnetic stripe reader disposed on the rear surface of the case body adjacent to the bottom surface, the magnetic stripe reader being configured to read stored data from magnetic stripe cards;
at least two hot-swappable batteries configured to be removably attachable to the protective case within the battery compartment, the at least two hot-swappable batteries being further configured to provide auxiliary power to the electronic device;
at least one microprocessor disposed within the protective case, the at least one microprocessor being electronically configured to establish data communication between the electronic device and the least two hot-swappable batteries, the keyboard, and the magnetic stripe reader;
a stylus having a stylus body that is elongate along a central axis, the stylus body extending from a pressure-sensitive stylus tip to a stylus head, the pressure-sensitive style tip being configured to engage with the screen of the electronic device, the stylus body comprising a shift button configured to enable alternate functionality when the pressure-sensitive stylus tip engages with the screen of the electronic device;
a docking station, the docking station generally comprising a dock body, a docking portion, a battery charging portion, and a back dock portion, the docking portion being configured to electronically and physically engage with the electronic device when the electronic device is disposed within the protective case to define a docked configuration, the battery charging portion being configured to mate with either a first or second of the at least two hot-swappable batteries so as to provide power to the first or second of the at least two hot-swappable batteries via an external power supply;
a rain shield configured to cover an entirety of a screen of the cell phone in an installed configuration, the rain shield defining a front rain shield surface and an opposed rear rain shield surface, the rear rain shield surface being configured to abut the screen of the cell phone in the installed configuration, the rain shield being further configured to communicate with the screen of the cell phone when strong forces are applied to the front rain shield surface and to inhibit communication with the screen of the cell phone when weak forces are applied to the front rain shield surface.

23. The kit of claim 22, further comprising a carrier case comprising ballistic nylon, the carrier case designed and configured to encapsulate the protective case and the cell phone when the cell phone is disposed in the protective case, the carrier case further comprising an attachment component configured to mount the carrier case to a user of the protective case, the carrier case further comprising a plurality of pockets, the pockets configured to contain at least the stylus, at least one of the at least two hot-swappable batteries, and a secondary rain shield.

24. The kit of claim 22, further comprising a hand-strap disposed on the rear portion of the case body, the hand strap being configured to permit removable attachment of protective case to a user of the protective case.

25. The kit of claim 22, further comprising a printer configured to be disposed on the rear surface of the case body, the printer being electronically connectable to the electronic device such that the electronic device can generate printing commands to be received and fulfilled by the printer.

26. A method for powering an electronic device, the method comprising the steps of:
instructing the electronic device to draw power from an internal rechargeable battery in the electronic device while the internal rechargeable battery has a power reserve of at least 50%;
when the internal rechargeable battery has a power reserve of 50% or less, instructing the electronic device to draw power from a first hot-swappable battery while the first hot-swappable battery has a power reserve of at least 50%;
when the hot-swappable battery has a power reserve of 50% or less, instructing the electronic device to display a first alert that signifies that the first hot-swappable battery should be replaced by a second hot-swappable battery;
when the first hot-swappable battery is removed, instructing the electronic device to draw power from the internal rechargeable battery until the second hot-swappable battery has replaced the first hot-swappable battery.

27. The method of claim 26, wherein the instructing steps are performed by at least one microprocessor, the at least one microprocessor being further configured to establish electronic communication between the electronic device, the internal rechargeable battery, and the hot-swappable battery.

28. The method of claim 27, wherein the at least one microprocessor calculates the length of time in hours that the internal rechargeable battery could exclusively provide power to the electronic device based upon the measured value Y at a given moment in time.

29. The method of claim 28, wherein the alert is a first alert, and wherein the at least one microprocessor instructs the electronic device to display a second alert that is different from the first alert when the at least one microprocessor calculates that the internal rechargeable battery is capable of providing less than 1 hour of power to the electronic device.

30. The method of claim 27, wherein the at least one microprocessor instructs the hot-swappable battery to initiate a charging cycle, the charging cycle being defined by the hot-swappable battery will diverting its stored power to the internal battery of the electronic device.

31. A kit case configured for use with an electronic device, the kit comprising:
a protective case defining a case body, the protective case being configured to retain the electronic device, the case body further defining an integration plug, disposed within the recess, the integration plug configured to mate with a corresponding port on the electronic device to provide an electronic connection therebetween;
at least one microprocessor disposed within the case body;
at least one external device removably connectable to the protective case, wherein the at least one microprocessor is configured to establish data communication between the electronic device and the at least one external device.

32. The kit of claim 31, wherein the at least one external device is a plurality of external devices and the at least one microprocessor is configured to electronically communicate with each of the plurality of electronic devices simultaneously.

33. The kit of claim 31, wherein the at least one external device is a hot-swappable battery configured to provide auxiliary power to the electronic device.

34. The kit of claim 31, wherein the at least one external device is a keyboard comprising a plurality of keys, each one of the plurality of keys corresponding to at least one alpha-numeric character.

35. The kit of claim 31, the at least one external device is a magnetic stripe reader configured to extract magnetically stored data contained within magnetic stripe cards.

36. The kit of claim 31, the at least one external device is a printer configured to receive and fulfill printing commands generated by the electronic device.
